(19) United States
(12) Patent Application Publication
(10) Pub. No.: US 2009/0002274 A1
(43) Pub. Date: Jan. 1, 2009

(54) OPTICALLY WRITABLE DISPLAY MEDIUM, OPTICAL WRITING DEVICE, AND IMAGE DISPLAY APPARATUS

(75) Inventors: Minoru KOSHIMIZU, Kanagawa (JP); Tsutomu ISHII, Kanagawa (JP); Naoki HIJI, Kanagawa (JP); Yasunori SAITO, Kanagawa (JP); Haruo HARADA, Kanagawa (JP); Masahiro SATO, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/038,447

(22) Filed: Feb. 27, 2008

(30) Foreign Application Priority Data
Jun. 29, 2007 (JP) 2007-172322

(51) Int. Cl. G09G 3/02; G11B 7/26; G11B 7/00

(52) U.S. Cl. 345/32; 369/283; 369/100

(57) ABSTRACT

An optically writable display medium, which includes a display layer, a photoconductor layer and a pair of electrodes, is provided. The display layer is capable of selectively reflecting incident light in response to an applied voltage and it has memory capability. Electrical resistance of the photoconductor layer changes in response to writing light with which the photoconductor layer is irradiated. The pair of electrodes are disposed such that the display layer and the photoconductor layer are interposed therebetween, with at least one of the electrodes having plural segmented electrodes juxtaposed along a predetermined direction. Each power receiving terminal of the plural segmented electrodes is disposed such that part of a region of the power receiving terminal of each segmented electrode overlaps, in the predetermined direction, but does not contact part of a region of the power receiving terminal of the segmented electrode that is adjacent thereto.

### CROSS-REFERENCE TO RELATED APPLICATION

This application is based on and claims priority under 35 USC 119 from Japanese Patent Application No. 2007-172322 filed Jun. 29, 2007.

### BACKGROUND

1. Technical Field

The present invention relates to an optically writable display medium, an optical writing device, and an image display apparatus.

2. Related Art

Conventionally, various media and technologies have been disclosed as optically writable image display media having memory capability and technologies that write images on such image display media.

### SUMMARY

According to an aspect of the invention, there is provided an optically writable display medium. The optically writable display medium includes: a display layer that is capable of selectively reflecting incident light in response to a voltage applied from an external electric source and that has memory capability of its reflection state without the voltage; a photoconductor layer whose electrical resistance changes in response to writing light with which the photoconductor layer is irradiated; and a pair of electrodes disposed such that the display layer and the photoconductor layer are interposed therebetween, with at least one of the electrodes comprising plural segmented electrodes juxtaposed along a predetermined direction. In the writable display medium, each of the plural segmented electrodes have a power receiving terminal from where the voltage applied with a contact by a contact electrode of the external power source, the each of the power receiving terminals disposed such that each of the power receiving terminals of each of the adjacent segmented electrodes are overlapped in the predetermined direction, but do not electrically contact each other.

### BRIEF DESCRIPTION OF THE DRAWINGS

An exemplary embodiment of the present invention will be described in detail based on the following figures, wherein:

FIG. 1 is a cross-sectional diagram of a display medium;

FIG. 2 is a general configural diagram of an optical writing device;

FIG. 3 is a circuit diagram showing an equivalent circuit of the display medium;

FIG. 4A is a schematic descriptive diagram showing the relationship between molecular orientation and optical characteristics of a cholesteric liquid crystal in a planar phase;

FIG. 4B is a schematic descriptive diagram showing the relationship between molecular orientation and optical characteristics of a cholesteric liquid crystal in a focal conic phase;

FIG. 4C is a schematic descriptive diagram showing the relationship between molecular orientation and optical characteristics of a cholesteric liquid crystal in a homeotropic phase;

FIG. 5 is a graph for describing switching behavior of a cholesteric liquid crystal;

FIG. 6 is a diagram showing the arrangement of plural segmented electrodes that configure a transparent electrode and power receiving terminals disposed on the segmented electrodes, which diagram also shows the positional relationship between the power receiving terminals and a power feeding roll;

FIG. 7 is a diagram showing the shape of the power receiving terminals disposed on the segmented electrodes;

FIG. 8 is a descriptive diagram describing a state when writing an image on the display medium;

FIG. 9 is a timing chart showing an ideal timing between a power feeding period with respect to one of the segmented electrodes and a light irradiation period with respect to a region corresponding to that segmented electrode;

FIG. 10 is a side diagram showing a power feeding region of a power feeding roll with respect to the power receiving terminals disposed on the segmented electrodes and an exposure region of a light irradiating component;

FIG. 11 is a timing chart showing a power feeding period with respect to adjacent two segmented electrodes and a light irradiation timing with respect to a region corresponding to those two segmented electrodes;

FIG. 12 is a diagram showing a modification of the disposed positions of the power receiving terminals;

FIG. 13 is a diagram showing a modification of the power receiving terminals; and

FIG. 14 is a diagram showing the shape of the power receiving terminals disposed on the segmented electrodes shown in FIG. 13.

### DETAILED DESCRIPTION

Below, an exemplary embodiment of the present invention will be described.

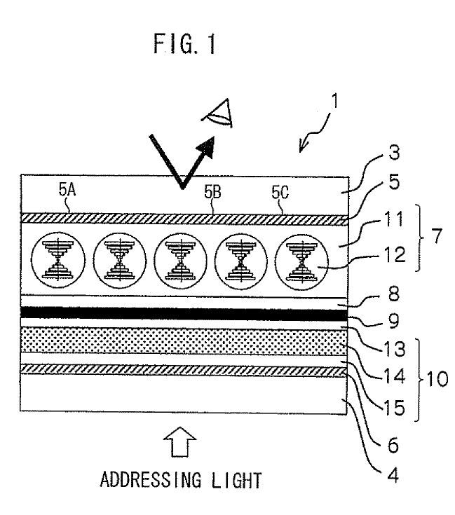

FIG. 1 shows a cross-sectional diagram of an optically writable display medium 1 of the present exemplary embodiment. The display medium 1 is a display medium capable of recording an image as a result of being irradiated with addressing light (writing light) corresponding to an image and a bias signal (voltage) being applied thereto.

As shown in FIG. 1, the display medium 1 is configured by a transparent substrate 3, a transparent electrode 5, a display layer (liquid crystal layer) 7, a laminate layer 8, a colored layer (light-shielding layer) 9, a photoconductor layer 10, a transparent electrode 6, and a transparent substrate 4, which are laminated in this order from a display surface side of the display medium 1.

The transparent substrates 3 and 4 are for holding functional layers inside to maintain the structure of the display medium. The transparent substrates 3 and 4 are configured by sheet-like members having strength capable of withstanding external force. The transparent substrate 3 on the display surface side transmits at least incident light, and the transparent substrate 4 on a writing surface side transmits at least addressing light. It is preferable for the transparent substrates 3 and 4 to have flexibility. Specific examples of the material thereof may include an inorganic sheet (e.g., glass or silicon) and a polymer film (e.g., polyethylene terephthalate, polysulfone, polyethersulfone, polycarbonate, polyethylene naphthalate). Known functional films—such as an antifouling film, an antiwear film, an antireflection film, and a gas barrier film—may also be formed on the outer surfaces of the transparent substrates 3 and 4.

It will be noted that it suffices for the transparent substrates 3 and 4 to have at least translucency and that it is not invariably necessary for them to be transparent.

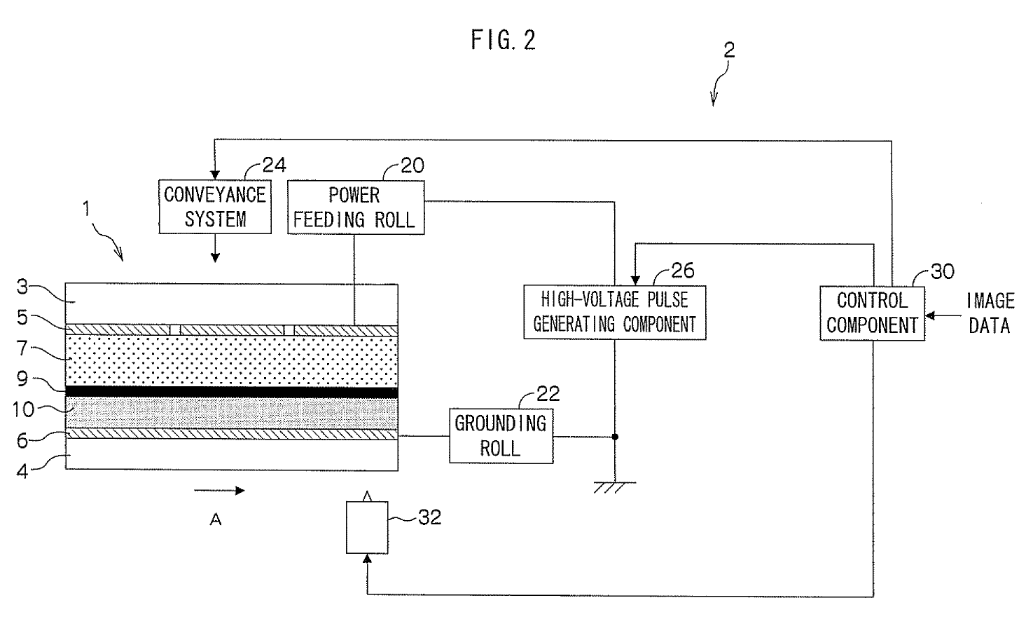

The transparent electrodes 5 and 6 are for applying, to the functional layers inside the display medium 1, a bias voltage applied from an optical writing device shown in FIG. 2.

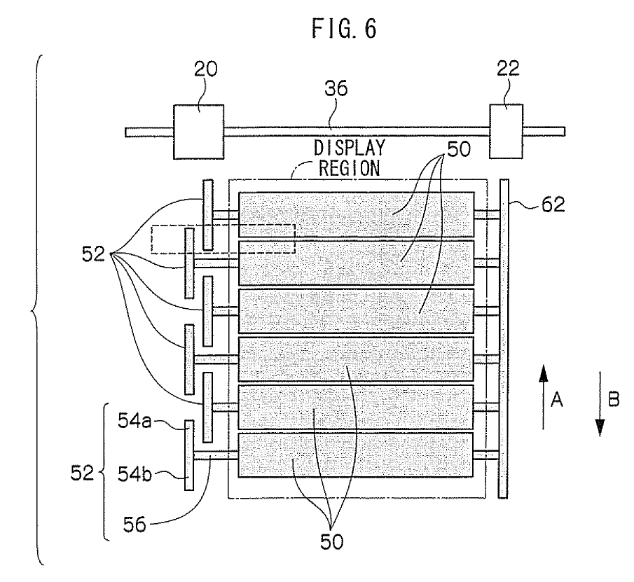

FIG. 6 is a diagram showing the arrangement of plural segmented electrodes 50 that configure the transparent electrode 5 and power receiving terminals 52 disposed on each of the segmented electrodes 50, which diagram also shows the positional relationship between the power receiving terminals 52 and a power feeding roll 20 (described later). It will be noted that arrow A in the diagram represents a conveyance direction (moving direction) of the display medium 1 and arrow B represents an image writing direction with respect to the display medium 1.

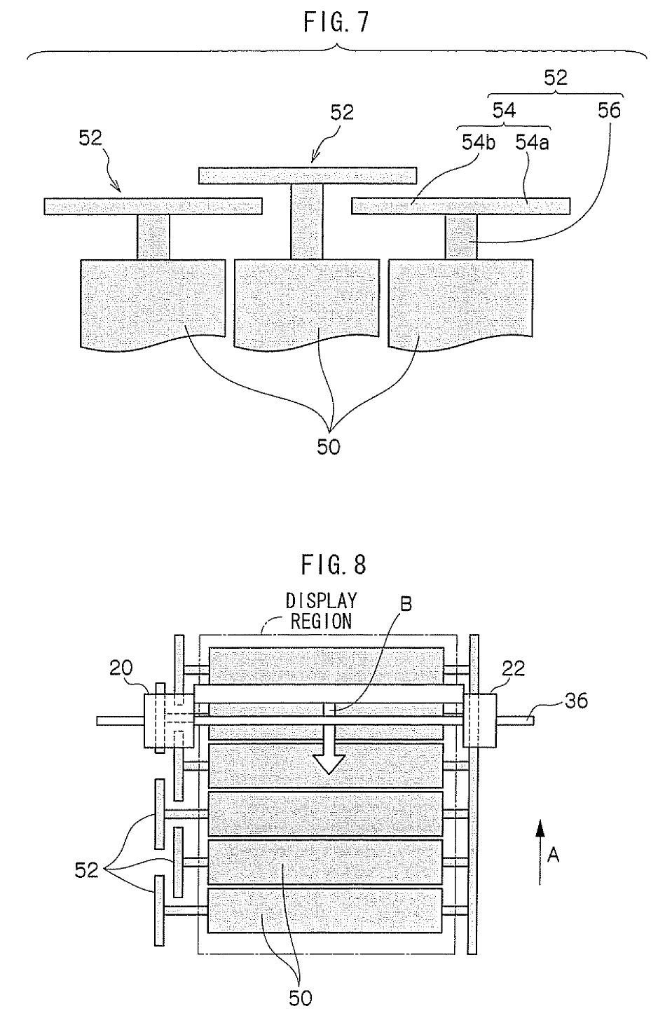

As shown in FIG. 6, in the present exemplary embodiment, as an example, the transparent electrode 5 is configured such that six segmented electrodes 50 having substantially the same shape (e.g., a rectangular shape) are juxtaposed along the direction of arrow B of the display medium 1 in a state where there is a minute gap between each adjacent pair of segmented electrodes 50. Further, a power receiving terminal 52 is disposed on each of the segmented electrodes 50, and a voltage is applied via the power receiving terminals 52 to the corresponding segmented electrodes 50. Each of the power receiving terminals 52 has a “T” shape comprising a horizontal site 54 and a vertical site 56. As shown in FIG. 7, a right side end portion 54a of the horizontal site 54 (it will be noted that in FIG. 6, the power receiving terminals 52 have a T shape rotated 90° to the left, and the horizontal sites 54 extend in a vertical direction) of each of the power receiving terminals 52 is disposed such that it overlaps, along the direction of arrow B, but does not contact a left side end portion 54a of the horizontal site 54 of the power receiving terminal 52 of the adjacent segmented electrode 50, and the left side end portion 54b of the horizontal site 54 of each of the power receiving terminals 52 is disposed such that it overlaps, along the direction of arrow B, but does not contact the right side end portion 54a of the T-shaped horizontal site 54 of the power receiving terminal 52 of the adjacent segmented electrode 50. Additionally, the perpendicular site 56 of each of the power receiving terminals 52 is connected to the corresponding segmented electrode 50.

Further, the transparent electrode 6 is configured by a single transparent electrode having an area corresponding to substantially the entire surface of the display medium 1. A power receiving terminal 62 is connected to the transparent electrode 6, and a voltage is applied via the power receiving terminal 62 to the transparent electrode 6.

The transparent electrodes 5 and 6 have plane-uniform electroconductivity. The transparent electrode 5 on the display surface side transmits at least incident light, and the transparent electrode 6 on the writing surface side transmits at least addressing light. A specific example may include an electroconductive thin film formed by a metal (e.g., gold, aluminium), a metal oxide (e.g., indium oxide, tin oxide, indium tin oxide (ITO)), or an electroconductive organic polymer (e.g., a polythiophene polymer or a polyaniline polymer). Know functional films—such as an adhesive force improving film, an antireflection film, and a gas barrier film—may also be formed on the surfaces of the transparent electrodes 5 and 6.

It will be noted that it suffices for the transparent electrodes 5 and 6 to have at least translucency and that it is not invariably necessary for them to be transparent.

The display layer 7 has a function such that the reflected or transmitted state of light of a specific color of incident light is modulated by an electric field and has the property that the selected state can be held under no electric field. It is preferable for the display layer 7 to have a structure that does not deform with respect to external force, such as flexure and pressure.

In the present exemplary embodiment, as an example, the display layer 7 is configured by a liquid crystal layer of a self-holding liquid crystal composite comprising a cholesteric liquid crystal and a transparent resin. That is, the liquid crystal layer does not require a spacer or the like because the composite has self-holdability, but the display layer 7 is not limited to this. In the present exemplary embodiment, as shown in FIG. 1, the display layer 7 comprises a cholesteric liquid crystal 12 dispersed in a polymer matrix (transparent resin) 11.

The cholesteric liquid crystal 12 has the function of modulating the reflected or transmitted state of light of a specific color of incident light. The liquid crystal molecules of the cholesteric liquid crystal 12 are oriented such that they are helically twisted, and, of light made incident from the helical axis direction, the cholesteric liquid crystal 12 interferes with and reflects specific light dependent on the helical pitch. The orientation of the liquid crystal molecules is changed by an electric field so that the reflected state can be changed. It is preferable for the drop size to be uniform and for the liquid crystal molecules to be disposed densely in a single layer.

Specific examples of liquid crystals that can be used as the cholesteric liquid crystal 12 may include a nematic liquid crystal or a smectic liquid crystal (e.g., Schiff base, azo, azoxy, benzoate ester, biphenyl, terphenyl, cyclohexylcarboxylic ester, phenylcyclohexane, biphenylcyclohexane, pyrimidine, dioxane, cyclohexylcyclohexane ester, cyclohexylethane, cyclohexane, tolan, alkenyl, stilbene, and polycondensed ring liquid crystals), or a mixture thereof having a chiral agent (e.g., steroidal cholesterol derivative, Schiff base, azo, ester, or biphenyl agent) added thereto.

The helical pitch of the cholesteric liquid crystal is adjusted by the added amount of the chiral agent with respect to the nematic liquid crystal. For example, in a case where the display colors are blue, green, and red, the center wavelengths of selective reflection are in the ranges of 400 nm to 500 nm, 500 nm to 600 nm, and 600 nm to 700 nm, respectively. Further, in order to compensate for temperature dependency of the helical pitch of the cholesteric liquid crystal, a known technique of adding plural chiral agents having different twist directions or opposite temperature dependencies may also be used.

As the mode of forming the self-holding liquid crystal composite comprising where the liquid crystal layer 7 comprises the cholesteric liquid crystal 12 and the polymer matrix (transparent resin 11), a polymer network liquid crystal (PNLC) structure including a network resin within a continuous phase of a cholesteric liquid crystal or a polymer dispersed liquid crystal (PDLC) structure (including one that is microencapsulated) where a cholesteric liquid crystal is dispersed as droplets in a polymer skeleton can be used. By giving the self-holding liquid crystal composite a PNLC structure or a PDLC structure, an anchoring effect is created at the interfaces between the cholesteric liquid crystal and the polymer, and the held state of the planar phase or the focal conic phase under no electric field can be made more stable.

The PNLC structure or PDLC structure can be formed by known methods of inducing phase separation of polymers and liquid crystals, such as the polymerization induced phase separation (PIPS) method, where a polymer precursor that is polymerized by heat, light, or an electron beam or the like, such as an acrylic, thiol or epoxy polymer precursor, is mixed with a liquid crystal, and the mixture is polymerized from the uniform phase to induce phase separation, the emulsion method, where a polymer having a low solubility to a liquid crystal, such as polyvinyl alcohol, is mixed together with a liquid crystal and agitated to disperse droplets of the liquid crystal in the polymer, the thermally induced phase separation (TIPS) method, where a thermoplastic polymer and a liquid crystal are mixed together and heated to obtain a uniform phase, which is then cooled to induce phase separation, and the solvent induced phase separation (SIPS) method, where a polymer and a liquid crystal are dissolved in a solvent such as chloroform, and the solvent is evaporated to induce phase separation of the polymer and the liquid crystal, but the method is not particularly limited.

The polymer matrix 11 has the function of holding the cholesteric liquid crystal 12 to control flowage of the liquid crystal (changes in images) resulting from deformation of the display medium. Preferred examples thereof may include polymer materials that do not dissolve in a liquid crystal material but do dissolve in a liquid solvent that is not compatible with the liquid crystal. Further, it is desirable for the polymer matrix 11 to be a material having strength capable of withstanding external force and which exhibits high transparency at least with respect to the reflection light and the addressing light.

Examples of materials that can be employed as the polymer matrix 11 may include water-soluble polymer materials (e.g., gelatin, polyvinyl alcohol, a cellulose derivative, a polyacrylic acid polymer, ethyleneimine, polyethylene oxide, polyacrylamide, polystyrene sulfonate salt, polyamidine, and an isoprene sulfonic acid polymer) or materials that can form an aqueous emulsion (e.g., a fluorine resin, a silicone resin, an acrylic resin, a urethane resin, or an epoxy resin).

The photoconductor layer 10 is a layer having an internal photoelectric effect and has the characteristic that its impedance characteristics change in response to the radiation intensity of the addressing light. It is preferable for the photoconductor layer 10 to be capable of being driven by alternating current and driven symmetrically with respect to the addressing light. The photoconductor layer 10 preferably has a three-layer structure where charge generating layers (CGL) are laminated on the top and bottom of a charge transporting layer (CTL). In the present exemplary embodiment, the photoconductor layer 10 comprises, as an example, an upper charge generating layer 13, a charge transporting layer 14, and a lower charge generating layer 15 that are laminated in order from the upper layer in FIG. 1.

The charge generating layers 13 and 15 are layers having the function of absorbing the addressing light to generate photocarriers. The charge generating layer 13 mainly controls the amount of photocarriers flowing in the direction of the transparent electrode 6 on the writing surface side from the transparent electrode 5 on the display surface side, and the charge generating layer 15 mainly controls the amount of photocarriers flowing in the direction of the transparent electrode 5 on the display surface side from the transparent electrode 6 on the writing surface side. It is preferable for the charge generating layers 13 and 15 to be layers that absorb the addressing light to generate excitons, which are efficiently separated into free carriers in the charge generating layers or at the interfaces between the charge generating layers and the charge transporting layer.

The charge generating layers 13 and 15 can be formed by a dry method, where a charge generating material (e.g., a metallic or non-metallic phthalocyanine, a squalirium compound, an azulenium compound, a perylene compound, an indigo pigment, a bis- or tris-azo pigment, a quinacridone pigment, a pyrrolopyrrole colorant, a polycyclic quinone pigment, a condensed aromatic pigment such as dibromoanthanthrone, a cyanine colorant, a xanthene pigment, a charge transfer complex such as polyvinylcarbazole and nitrofluorene, and an eutectic complex comprising a pyrylium salt dye and a polycarbonate resin) is directly formed into a film, or by a wet coating method, where a charge generating material is dispersed or dissolved in an appropriate solvent together with a polymer binder (e.g., a polyvinyl butyral resin, a polyarylate resin, a polyester resin, a phenol resin, a vinylcarbazole resin, a vinyl formal resin, a partially modified vinylacetal resin, a carbonate resin, an acrylic resin, a vinyl chloride resin, a styrene resin, a vinyl acetate resin, and a silicone resin) to obtain a coating composition, which is then applied and dried to form a film.

The charge transporting layer 14 is a layer having a function such that the photocarriers generated in the charge generating layers 13 and 15 are injected therein and drift in the direction of an electric field applied by the bias signal. Usually the charge transporting layer has a thickness that is several tens of times the thickness of the charge generating layers, so the contrast impedance of the entire photoconductor layer 10 is determined by the capacity of the charge transporting layer 14, the dark current of the charge transporting layer 14, and the photocarrier current inside the charge transporting layer 14.

In the charge transporting layer 14, it is preferred that the injection of free carriers from the charge generating layers 13 and 15 occurs efficiently (the charge transporting layer 14 preferably has an ionization potential close to those of the charge generating layers 13 and 15), and the free carriers thus injected undergo hopping migration at a rate as high as possible. In order to increase the dark impedance, it is preferable for the dark current resulting thermal carriers to be low.

The charge transporting layer 14 may be formed in such a manner that a low molecular weight hole transporting material (e.g., a trinitrofluorene compound, a polyvinylcarbazole compound, an oxadiazole compound, a hydrazone compound such as benzylamino hydrazone or quinoline hydrazone, a stilbene compound, a triphenylamine compound, a triphenylmethane compound, a benzidine compound) or a low molecular weight electron transporting material (e.g., a quinone compound, a tetracyanoquinodimethane compound, a fluorenone compound, a xanthone compound, a benzophenone compound) is dispersed or dissolved in a suitable solvent together with a polymer binder (e.g., a polycarbonate resin, a polyarylate resin, a polyester resin, a polyimide resin, a polyamide resin, a polystyrene resin, a silicon-containing crosslinked resin) to obtain a coating composition, or alternatively the hole transporting material or the electron transporting material is formed into a polymer, which is then dispersed or dissolved in a suitable solvent to obtain a coating composition, and the coating composition is applied and dried.

The colored layer (light-shielding layer) 9 is a layer disposed for the purpose of optically separating the addressing light and the incident light during writing to prevent malfunction due to mutual interference and optically separating outside light made incident from the non-display surface side of the display medium and the display image during display to prevent deterioration of the image. The colored layer 9 is not an essential constituent element in the present exemplary embodiment. However, it is desirable for the colored layer 9 to be disposed in order to improve the performance of the display medium 1. In consideration its purpose, the colored layer 9 is required to have a function of absorbing at least light in the absorption wavelength region of the charge generating layers and light in the reflection wavelength region of the display layer.

The colored layer 9 may be formed, for example, by a dry method, where an inorganic pigment (e.g., a cadmium series, a chromium series, a cobalt series, a manganese series, a carbon series) or an organic dye or an organic pigment (an azo series, an anthraquinone series, an indigo series, a triphenylmethane series, a nitro series, a phthalocyanine series, a perylene series, a pyrrolopyrrole series, a quinacridone series, a polycyclic quinone series, a squalirium series, an azulenium series, a cyanine series, a pyrylium series, an antlirone series) is directly formed into a film on the surface of the photoconductor layer 10 on the charge generating layer 13 side, or a wet coating method, where the pigment or dye is dispersed or dissolved in a suitable solvent together with a polymer binder (e.g., , a polyvinyl alcohol resin, a polyacrylic resin) to obtain a coating composition, which is then coated and dried to form a film.

The laminate layer 8 is a layer disposed for the purpose of fulfilling the role of adhesion and absorbing unevenness when the functional layers that have been formed on the inner surfaces of the upper and lower substrates are adhered to each other. The laminate layer 8 is not an essential constituent element in the present exemplary embodiment. The laminate layer 8 comprises a polymer material whose glass transition temperature is low, and a material that can allow the display layer 7 and the colored layer 9 to be brought into close contact/adhered together through heat or pressure is selected. Further, the laminate layer 8 must be permeable at least with respect to incident light.

Examples of materials suitable for the laminate layer 8 may include adhesive polymer materials (e.g., a urethane resin, an epoxy resin, an acrylic resin, a silicone resin).

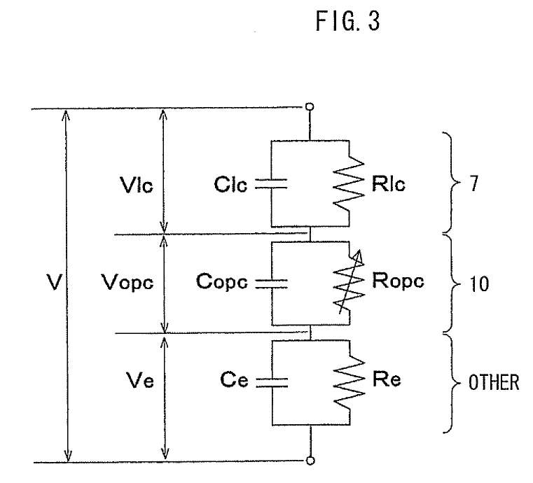

FIG. 3 is a circuit diagram showing an equivalent circuit of the display medium (liquid crystal device) 1 having the structure shown in FIG. 1. Clc and Copc and Rlc and Ropc represent the electrostatic capacities and the resistances of the display layer 7 and the photoconductor layer 10, respectively. Ce and Re represent the equivalent electrostatic capacity and the equivalent resistance of constituent elements other than the display layer 7 and the photoconductor layer 10.

Assuming that V represents the voltage applied from the external writing device 2 between the transparent electrode 5 and the transparent electrode 6 of the display medium 1, partial voltages Vlc, Vopc and Ve that are determined by the impedance ratio among the constitutional elements are applied to each of the constitutional elements. More specifically, immediately after a voltage has been applied, partial voltages determined by the capacity ratio of each constitutional element arise and, with the lapse of time, the partial voltages are relaxed to partial voltages that are determined by the resistance ratio of each constitutional element.

Here, the resistance Ropc of the photoconductor layer 10 chances in response to the intensity of the addressing light, so the effective voltage applied to the display layer 7 can be controlled by exposure and non-exposure. During exposure, the resistance Ropc of the photoconductor layer 10 becomes lower and the effective voltage applied to the display layer 7 becomes larger; conversely, during non-exposure, the resistance Ropc of the photoconductor layer 10 becomes larger and the effective voltage applied to the display layer 7 becomes smaller.

Next, the cholesteric liquid crystal (chiral nematic liquid crystal) 12 will be specifically described. The planar phase that the cholesteric liquid crystal 12 exhibits gives rise to a selective reflection phenomenon, where light made incident parallel to the helical axis is separated into rightward light and leftward light, the circularly-polarized light component coinciding with the twist direction of the helix undergoes Bragg reflection, and the remaining light is transmitted. Assuming that p represents the helical pitch, n represents the average refractive index within a plane orthogonal to the helical axis, and An represents the birefringence, then the center wavelength ) and reflected wavelength width Δλ of the reflected light are expressed as λ=n·p and Δλ=n·p, and the reflected light resulting from the cholesteric liquid crystal layer in the planar phase exhibits vivid color that is dependent on the helical pitch.

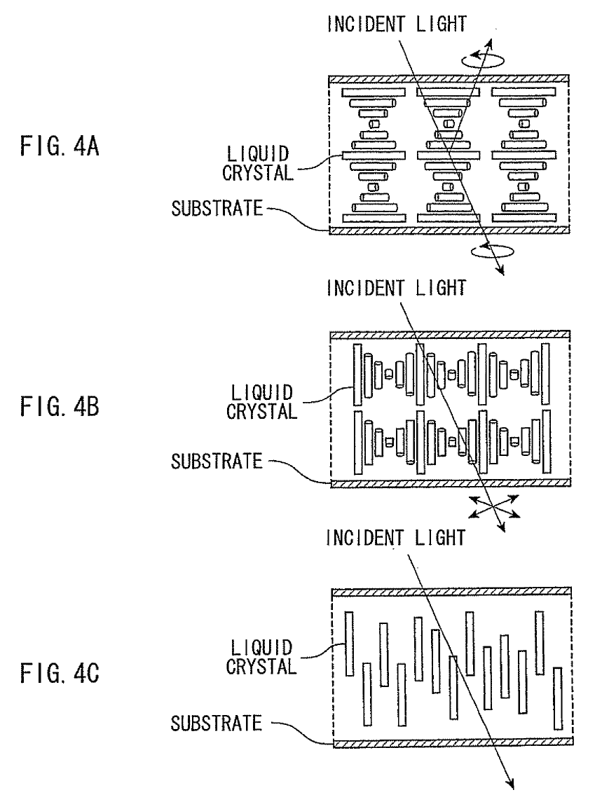

A cholesteric liquid crystal having a positive dielectric anisotropy exhibits three states: as shown in FIG. 4A, a planar phase where the helical axis is perpendicular to the cell surface and which gives rise to the above-described selective reflection phenomenon with respect to incident light; as shown in FIG. 4B, a focal conic phase where the helical axis is substantially parallel to the cell surface and incident light is transmitted being scattered slightly forward; and as shown in FIG. 4C, a homeotropic phase where the helical structure unravels, the liquid crystal director faces the electric field direction, and incident light is almost completely transmitted.

Of these three states, the planar phase and the focal conic phase can exist bistably under no electric field. Consequently, the phase state of a cholesteric liquid crystal is not unambiguously determined with respect to the intensity of the electric field applied to the liquid crystal layer. When the planar phase is the initial state, the liquid crystal changes in the order of the planar phase, the focal conic phase and the homeotropic phase as the intensity of the electric field increases, and when the focal conic phase is the initial phase, the liquid crystal changes in the order of the focal conic phase and the homeotropic phase as the intensity of the electric field increases.

On the other hand, when the intensity of the electric field applied to the liquid crystal layer is suddenly changed to zero, then the planar phase and the focal conic phase maintain their states as they are and the homeotropic phase changes to the planar phase.

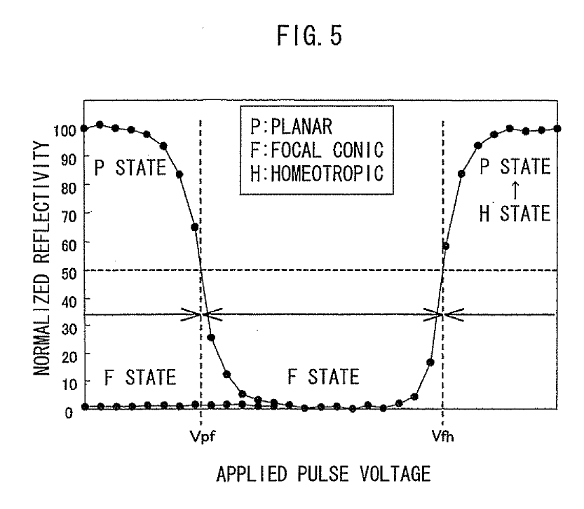

Consequently, a cholesteric liquid crystal immediately after a pulse signal has been applied thereto exhibits switching behavior such as shown in FIG. 5. When the voltage of the applied pulse signal is equal to or greater than Vfh, then the liquid crystal is in a selective reflection state where it has changed from the homeotropic phase to the planar phase, when the voltage of the applied pulse signal is between Vpf and Vfh, then the liquid crystal is in a transmitting state resulting from the focal conic phase, and when the voltage of the applied pulse signal is equal to or less than Vpf, then the liquid crystal maintains its state prior to application of the pulse signal, that is, the selective reflection state resulting from the planar phase or the transmitting state resulting from the focal conic phase.

In FIG. 5, the vertical axis represents normalized reflectivity, and reflectivity is normalized with 100 representing maximum reflectivity and 0 representing minimum reflectivity. Further, because a transition region exists between each of the planar phase, the focal conic phase and the homeotropic phase, the selective reflection state is defined as when the normalized reflectivity is equal to or greater than 50, the transmitting state is defined as when the normalized reflectivity is less than 50, Vpf represents the threshold value voltage of the phase change between the planar phase and the focal conic phase, and Vfh represents the threshold value voltage of the phase change between the focal conic phase and the homeotropic phase.

Particularly in a liquid crystal layer having a polymer network liquid crystal (PNLC) structure including a network resin within a continuous phase of cholesteric liquid crystal or a polymer dispersed liquid crystal (PDLC) structure (including one that is microencapsulated) where a cholesteric liquid crystal is dispersed as droplets in a polymer, bistability under no electric field in the planar phase and the focal conic phase improves because of interference at the interfaces between the cholesteric liquid crystal and the polymer (anchoring effect), and the state immediately after pulse signal application can be held over a long period of time.

The display medium 1 that uses the cholesteric liquid crystal 12 utilizes the bistable phenomenon of the cholesteric liquid crystal to switch between the selective reflection state resulting from the planar phase and the transmitting state resulting from the focal conic phase, whereby the display medium 1 performs black-and-white monochrome display that has memory capability under no electric field or color display that has memory capability under no electric field.

In response to the magnitude of the externally applied voltage, when the initial state of the cholesteric liquid crystal 12 is the planar phase state (P state) or the homeotropic state (H state), then the cholesteric liquid crystal 12 changes to the P state or the focal conic phase state (F state), when the initial state of the cholesteric liquid crystal 12 is the F state, then the cholesteric liquid crystal 12 changes to the F state and the H state, and when the final state is the P state and the F state, then that state is maintained even after the applied voltage is removed, and when the final state is the H state, then the cholesteric liquid crystal 12 phase-changes to the P state. Consequently, regardless of exposure/non-exposure, the P state or the F state is selected as the final phase state depending on the magnitude of the applied voltage. As shown in FIG. 5, in the P state, the cholesteric liquid crystal 12 reflects light, and in the F state, the cholesteric liquid crystal 12 transmits light.

Next, an image display apparatus shown in FIG. 2 will be described. The image display apparatus is configured to include the display medium 1 and the optical writing device 2.

The optical writing device 2 is a device that writes (records) an image on the display medium 1 and is configured to include a light irradiating component (exposure device) 32 that irradiates the display medium 1 with addressing light, a conveyance system 24 that causes the display medium 1 to move in the direction of arrow A in FIG. 2 and FIG. 6 such that the light irradiating component 32 and the display medium 1 relatively move, a high-voltage pulse generating component 26 that generates a bias voltage (high-voltage pulse) applied to the display medium 1, and a power feeding roll 20 and a grounding roll 22 for applying the voltage generated by the high-voltage pulse generating component 26 to the transparent electrodes 5 and 6. Moreover, the optical writing device 2 is configured to include a control component 30 that controls the conveyance system 24, the high-voltage pulse generating component 26 and the light irradiating component 32.

The high-voltage pulse generating component 26 is a circuit that generates a voltage (for writing an image) that is applied to the display medium 1 as mentioned previously. A bipolar high-voltage amp, for example, is used for the high-voltage pulse generating component 26. The power feeding roll 20 and the grounding roll 22 are connected to the high-voltage pulse generating component 26. The grounding roll 22 is grounded.

As shown in FIG. 6, the power feeding roll 20 and the grounding roll 22 are roll-like members that are supported on a rotary shaft 36 and rotate about the rotary shaft 36. When the leading edge of the display medium 1 is conveyed by the conveyance system 24 as far as a power feeding position where the power feeding roll 20 and the grounding roll 22 are disposed, the power feeding roll 20 contacts the power receiving terminals 52 disposed on the segmented electrodes 50 of the transparent electrode 5, and the grounding roll 22 contacts the power receiving terminal 62 disposed on the transparent electrode 6. It will be noted that the transparent electrode is disposed on the back surface side.

After the display medium 1 has been conveyed as far as the power feeding position, the display medium 1 is further conveyed in the direction of arrow A, and the power feeding roll 20 and the grounding roll 22 apply a voltage between the transparent electrodes 5 and 6 via the power receiving terminals 52 and the power receiving terminal 62 while passively rotating in accompaniment with the movement of the display medium 1 in the direction of arrow A in a state where the power feeding roll 20 and the grounding roll 22 contact the display medium 1.

The voltage value of the voltage for image writing that is applied between the transparent electrodes via the power feeding roll 20 and the grounding roll 22 is set to be at least a voltage value with which an image can be recorded on the display medium 1 when the voltage for image writing is applied between the transparent electrodes in a state where the display medium 1 is irradiated by the light irradiating component 32 with image light corresponding to image data. For example, when the orientation of the liquid crystals of the cholesteric liquid crystal 12 is changed from the P state to the F state to write an image, then the voltage value is a voltage value such that the voltage applied between the transparent electrodes at the site irradiated with the image light is within the range of a voltage larger than Vpf and smaller than Vfh, and when the orientation of the liquid crystal of the cholesteric liquid crystal 12 is chanced from the P state to the F state, then the voltage value is a voltage value such that the voltage applied between the transparent electrodes at the site irradiated with the image light becomes a voltage equal to or greater than Vfh.

The light irradiating component 32 irradiates the display medium 1 (more specifically, the top of the photoconductor layer 10) with an addressing light pattern (light image pattern) based on input signals (image data) corresponding to an image from the control component 30. As shown in FIG. 8, the light irradiating component 32 is configured in an elongate shape whose longitudinal direction is in a direction orthogonal to the direction of arrow A. Because the display medium 1 is conveyed in the direction of arrow A by the conveyance system 24, an image is sequentially written in the direction of white arrow B shown in the center of FIG. 8. It will be noted that a resetting light source may also irradiate the display medium 1 with resetting light for resetting (initializing) the display medium 1 prior to exposure by the light irradiating component 32. In the present exemplary embodiment, illustration and description in regard to a resetting light source that irradiates the display medium with resetting light are omitted.

It is desirable for the addressing light radiated by the light irradiating component 32 to be light that has peak intensity within the absorption wavelength range of the photoconductor layer 10 and has as narrow a bandwidth as possible.

As the light irradiating component 32, a component that can form an arbitrary two-dimensional light emission pattern by scanning is used—such as a component where a light source such as a cold cathode tube, a xenon lamp, a halogen lamp, a light emitting diode (LED), an electroluminescent (EL) device or a laser is disposed in a one-dimensionally array, or a component combined with a polygon mirror.

The conveyance system 24 causes the display medium 1 to move in the direction of arrow A in FIG. 2 and FIG. 6 in accordance with an instruction from the control component 30. The conveyance system 24 is configured to include a pulse motor, for example, and causes the display medium 1 to move in the direction of arrow A in the drawings as a result of being driven by the pulse motor. In the present exemplary embodiment, the positions of the power feeding roll 20, the grounding roll 22 and the light irradiating part 32 are fixed, and the conveyance system 24 conveys the display medium 1, whereby an image is written two-dimensionally in the display region shown in FIG. 6 and FIG. 8. It will be noted that the positional relationship between the power feeding roll 20 and the grounding roll 22 and the light irradiating part 32 is, as shown in FIG. 8, configured such that the positions where the power feeding roll 20 and the grounding roll 22 contact the power receiving terminals 52 and 62 are positioned slightly further upstream in the direction of arrow B than the light irradiation position (exposure position) of the light irradiating component 32.

The control component 30 instructs the conveyance system 24 such that the display medium 1 moves at a predetermined speed in the direction of arrow A in FIG. 2, controls on the basis of inputted image data such that the display medium 1 is irradiated by the light irradiating component 32 with image light (addressing light) based on image data inputted at a later-described timing, and controls the high-voltage pulse generating component 26 to apply a voltage.

Next, image writing operation with respect to the display medium 1 will be described.

First, the display medium 1 is set in a predetermined standby position upstream in the direction of arrow A. Thereafter, the control component 30 instructs the conveyance system 24 such that the display medium 1 starts moving in the direction of arrow A in FIG. 2 and FIG. 6.

When the control component 30 instructs the conveyance system 24 to start moving the display medium 1, the conveyance system 24 causes the display medium 1 to start moving. Thus, the display medium 1 starts moving at a predetermined moving velocity Va in the direction of arrow A in FIG. 2 and FIG. 6.

When the leading edge of the display medium 1 reaches the power feeding position, the control component 30 controls the high-voltage pulse generating component 26 to generate a voltage for image writing. Thus, a voltage is applied to the transparent electrodes 5 and 6 of the display medium 1 via the power feeding roll 20 and the grounding roll 22.

The feeding of power with respect to each of the segmented electrodes 50 is performed substantially during the period when the power feeding roll 20 is contacting the power receiving terminals 52 disposed on the segmented electrodes 50. Additionally, at the point in time when the power feeding roll 20 separates from the power receiving terminals 52, the feeding of power with respect to the segmented electrodes 50 corresponding to those power receiving terminals 52 ends.

As the conveyance system 24 conveys the display medium 1 in the direction of arrow A, a voltage is sequentially applied to the plural segmented electrodes 50, and the display medium 1 is irradiated with addressing light from the light irradiating component 32 during voltage application, and an image is written.

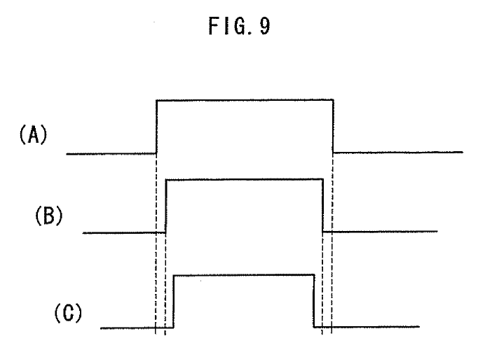

FIG. 9 is a timing chart showing the timing of a power feeding period with respect to one of the segmented electrodes 50 and a light irradiation period with respect to a region corresponding to that segmented electrode 50, which timing is realized by the present exemplary embodiment.

In FIG. 9, (A) represents a period in which the power receiving terminal 52 of one of the segmented electrodes 50 and the power feeding roll 20 are contacting each other, (B) represents a power feeding period with respect to that segmented electrode 50, and (C) represents a light irradiation period (exposure period) by the light irradiating component 32.

As shown in FIG. 9, within the period in which the power receiving terminal 52 and the power feeding roll 20 are contacting each other, a voltage is generated and the display medium 1 is irradiated with the addressing light within this voltage application period. That is, the voltage is applied just before the display medium is irradiated with the addressing light, and application of the voltage ends after irradiation with the addressing light ends. It will be noted that in the present exemplary embodiment, the high-voltage pulse generating component 26 is controlled such that, after it starts to generate a voltage, it continues to generate a bias voltage until all writing of the image with respect to the display medium 1 ends and, during the voltage application period, it is controlled as a result of the display medium 1 being moved. Consequently, in the present exemplary embodiment, the voltage application period is substantially identical to the period in which the power receiving terminal 52 and the power feeding roll 20 are contacting each other.

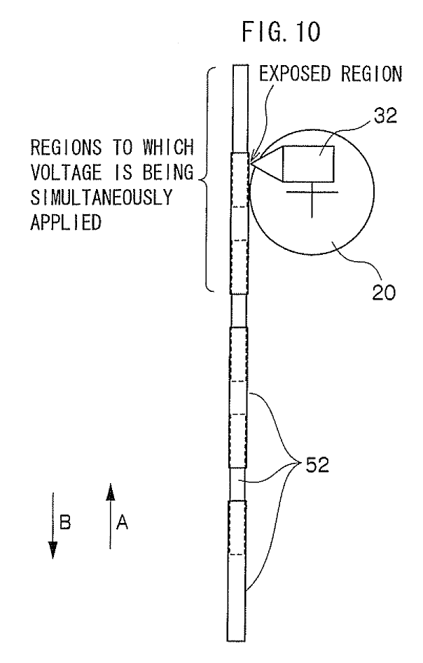

Further, in the present exemplary embodiment, the power receiving terminals 52 disposed on the segmented electrodes 50 of the display medium 1 have a “T” shape, and part of a region of each power receiving terminal 52 of each segmented electrode 50 overlaps, in the direction of arrow A (direction of arrow B), but does not contact part of a region of the power receiving terminal 52 of the segmented electrode 50 that is adjacent thereto. Consequently, at the overlap portion where the power receiving terminals of adjacent two segmented electrodes 50 overlap, the power feeding roll 20 contacts both of the power receiving terminals 52 so that a voltage is applied simultaneously to the adjacent two segmented electrodes 50. Below, this will be described using FIG. 10.

FIG. 10 is a side diagram showing a light exposure region of the light irradiating component 32 and a power feeding region of the power feeding roll 20 with respect to the power receiving terminals 52 disposed on the segmented electrodes 50.

As shown in FIG. 10, when the display medium 1 is conveyed and the power feeding roll 20 reaches an overlap portion where the power receiving terminals 52 of adjacent two segmented electrodes 50 overlap, then at this overlap portion, a voltage is applied to both of the two segmented electrodes 50 because the power feeding roll 20 contacts both of the power receiving terminals 52 of the two segmented electrodes 50 (see also the dotted line portion in FIG. 6).

In this manner, while a voltage is being applied simultaneously to adjacent two segmented electrodes 50, the control component 30 switches the region irradiated by the addressing light of the light irradiating component 32 between the adjacent two segmented electrodes 50 from upstream to downstream in the direction of arrow B.

FIG. 11 is a timing chart showing a power feeding period with respect to adjacent two segmented electrodes and a light irradiation timing with respect to a region corresponding to the two segmented electrodes.

As shown in (A) in FIG. 11, when the power feeding roll 20 contacts the power receiving terminal 52 of the first segmented electrode (upstream in the direction of arrow B) 50, application of a voltage to the first segmented electrode 50 begins (T1). Thereafter, as shown in (C) in FIG. 11, the control component 30 controls the light irradiating component 32 to start irradiation with the addressing light on the basis of image data (T2). Thereafter also, the conveyance system continues moving the display medium 1, and the overlap portion where the power receiving terminal 52 of the first (upstream in the direction of arrow B) segmented electrode 50 and the power receiving terminal 52 of the second (downstream in the direction of arrow B) segmented electrode 50 overlap reaches the power feeding position. At this time, as shown in (B) in FIG. 11, voltage application with respect to the second segmented electrode 50 is started, and a voltage is applied simultaneously to the adjacent two segmented electrodes 50 (T3). Thereafter, as shown in (C) in FIG. 11, the control component 30 stops irradiation of the addressing light by the light irradiating component 32 after irradiation of the addressing light with respect to the region corresponding to the first segmented electrode 50 ends. This is because the segmented electrodes 50 are disposed with minute gaps between each adjacent pair of the segmented electrodes 50, and the regions corresponding to these gaps are non-display regions.

When the display medium 1 is further conveyed in the direction of arrow A by the conveyance system 24, the exposure position of the light irradiating component 32 passes the aforementioned gap and reaches the region corresponding to the second segmented electrode 50. Thus, as shown in (C) in FIG. 11, the control component 30 controls the light irradiating component 32 to start exposure with respect to the region corresponding to the second segmented electrode 50 (T5). After the light irradiating component 32 starts exposure with respect to the region corresponding to the second segmented electrode 50, the conveyance system 24 further conveys the display medium 1, whereby the power receiving terminal 52 of the first segmented electrode 50 moves away from and out of contact with the power feeding roll 20, and power feeding with respect to the first segmented electrode 50 ends. Thereafter, irradiation of the addressing light with respect to the region corresponding to the second segmented electrode 50 ends (T7), and thereafter power feeding with respect to the second segmented electrode 50 ends (T8).

In this manner, while a voltage is being applied simultaneously with respect to the power receiving terminals 52 of the adjacent two segmented electrodes 50, the control component 30 switches the region irradiated with the addressing light from the region corresponding to the segmented electrode 50 of the two segmented electrodes 50 that is upstream in the direction of arrow B to the segmented electrode 50 that is downstream in the direction of arrow B.

The present invention is not limited to the preceding exemplary embodiment, and various design chances may be done within the scope of the invention described in the claims.

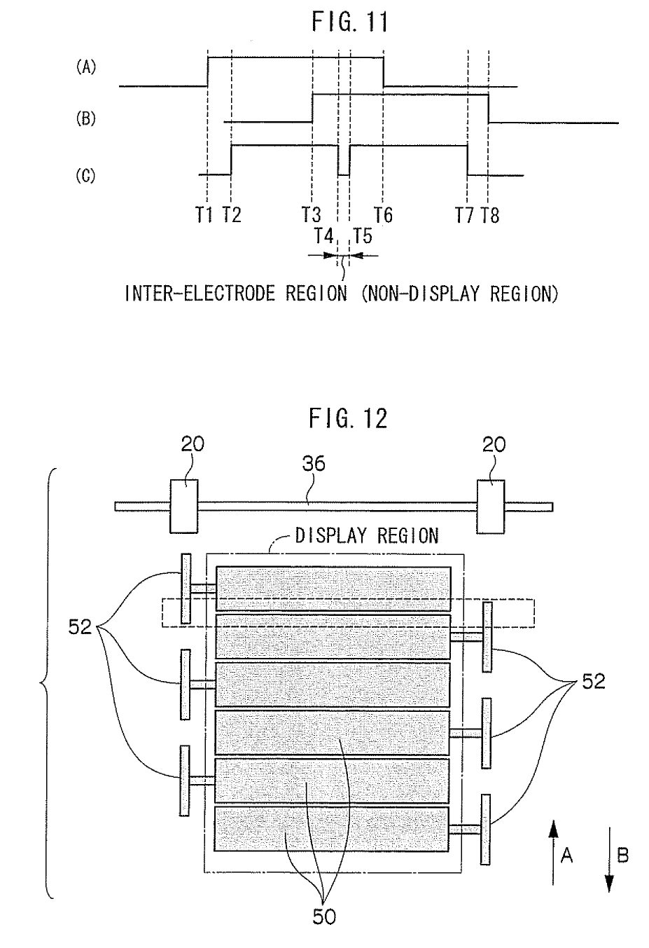

For example, in the preceding exemplary embodiment, an example has been described where the T-shaped power receiving terminals 52 were disposed on end portions on the same side of all of the segmented electrodes 50, but the invention is not limited to this. For example, as shown in FIG. 12, the invention may also be configured such that the power receiving terminals 52 of the segmented electrodes 50 are disposed on alternately different end portions along the direction of arrow B (i.e., where every other power receiving terminal 52 is disposed on an end portion on the same side). In this case, as shown in FIG. 12, one more power feeding roll 20 is disposed instead of the grounding roll 22 so that a voltage is applied to the power receiving terminals 52. It will be noted that the grounding roll 22 that grounds the transparent electrode 6 is disposed on the back surface side opposing the power feeding roll 20, and that the power receiving terminal 62 with respect to the transparent electrode 6 is also disposed on the back surface side.

Even with this configuration, parts of the regions of the power receiving terminals 52 of the segmented electrodes 50 overlap, in the direction of arrow B, but do not contact parts of the regions of the power receiving terminals 52 of the adjacent segmented electrodes 50 (see also the dotted line portion of FIG. 12). Consequently, similar to the preceding exemplary embodiment, a voltage is applied to the segmented electrodes sequentially from upstream in the direction of arrow B, the segmented electrodes are exposed to light sequentially from upstream in the direction of arrow B, and when the exposed region is to be switched at the boundary portion between adjacent two segmented electrodes 50, while a voltage is being applied simultaneously to the adjacent two segmented electrodes 50, the exposure timing is adjusted and the region irradiated with the addressing light of the light irradiating component 32 is switched from the region corresponding to the segmented electrode 50 that is upstream in the direction of arrow B to the region corresponding to the electrode 50 that is downstream, whereby an image is formed in the display region of the display medium 1.

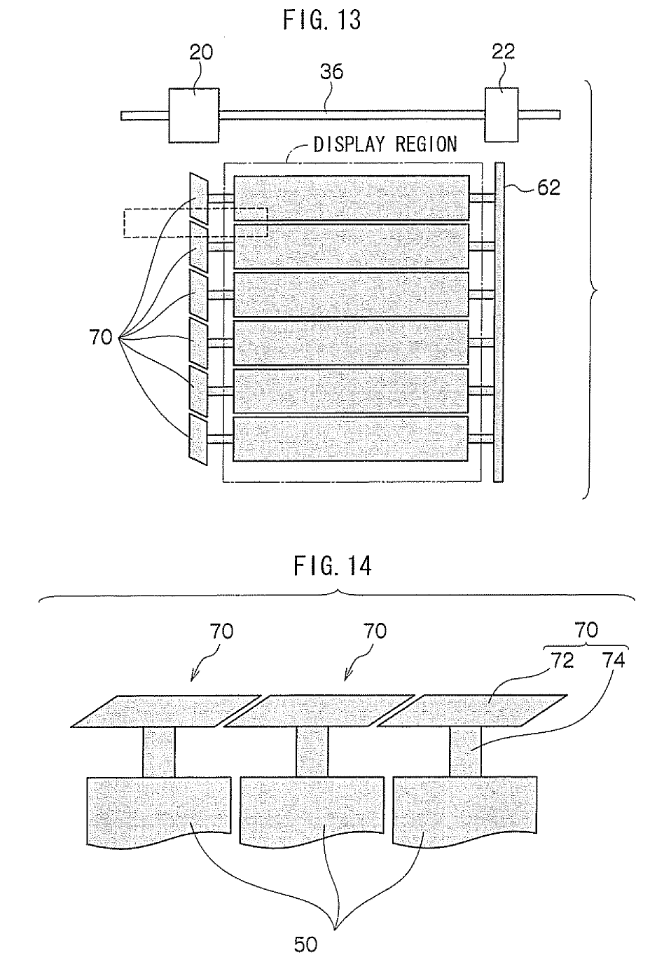

Further, power receiving terminals 70 having a shape such as shown in FIG. 13 may also be used instead of the power receiving terminals 52 of the preceding exemplary embodiment. As shown in the enlarged view of FIG. 14, the power receiving terminals 70 are formed such that width is imparted to horizontal sites 72, and both ends of each of the horizontal sites 72 are formed in diagonal shapes in the same direction and the same angle. The horizontal sites 72 and one end of each of perpendicular sites 74 are integrally formed, and the other end of each of the perpendicular sites 74 is connected to the end portions of the segmented electrodes 50. Further, each of both diagonally formed end portions of the horizontal sites 72 is disposed such that it overlaps, in the direction of arrow A, but does not contact one end portion of both diagonally formed end portions of the horizontal site 72 of the power receiving terminal 70 of the adjacent segmented electrode 50. By disposing the power receiving terminals 70 on the segmented electrodes 50 in this manner, similar to the preceding exemplary embodiment, at the portion where the power receiving terminals 70 of adjacent two segmented electrodes 50 overlap (see also the dotted line portion of FIG. 13), the power feeding roll 20 contacts the power receiving terminals 70 of both of the segmented electrodes 50, and a voltage is applied simultaneously to the adjacent two segmented electrodes 50.

In the preceding exemplary embodiment, a case has been described where a cholesteric liquid crystal was used as the display layer, but the invention is not limited to this and a ferroelectric liquid crystal may also be used.

Further, in the preceding exemplary embodiment, a case has been described where the display medium 1 was moved in a state where the power feeding roll 20, the grounding roll 22 and the light irradiating component 32 were fixed, whereby the power feeding roll 20, the grounding roll 22 and the light irradiating component 32 and the display medium 1 were relatively moved, but the invention may also be configured such that both are relatively moved by moving the power feeding roll 20, the grounding roll 22 and the light irradiating component 32 or by moving both.

Further, in the preceding exemplary embodiment, an example has been described where one of the transparent electrodes 5 and 6 was configured by segmented electrodes, but both of the transparent electrodes 5 and 6 may also be configured by segmented electrodes.

Further, in the preceding exemplary embodiment, a case has been described where there were six of the segmented electrodes, but the invention is not limited to this and is applicable also to a case where there are two or more and five or less, or seven or more, of the segmented electrodes.

What is claimed is:

1. An optically writable display medium comprising:
a display layer that is capable of selectively reflecting incident light in response to a voltage applied from an external electric source and that has memory capability of its reflection state without the voltage;
a photoconductor layer whose electrical resistance changes in response to writing light with which the photoconductor layer is irradiated; and
a pair of electrodes disposed such that the display layer and the photoconductor layer are interposed therebetween, with at least one of the electrodes comprising plural segmented electrodes juxtaposed along a predetermined direction,
wherein each of the plural segmented electrodes have a power receiving terminal from where the voltage applied with a contact by a contact electrode of the external power source, the each of the power receiving terminals disposed such that each of the power receiving terminals of each of the adjacent segmented electrodes are overlapped in the predetermined direction, but do not electrically contact each other.

2. An optical writing device comprising:
a voltage applying component that applies a voltage to a pair of electrodes of an optically writable display medium, which includes a display layer that is capable of selectively reflecting incident light in response to an applied voltage and which has memory capability of its reflection state without the voltage, a photoconductor layer whose electrical resistance changes in response to writing light with which the photoconductor layer is irradiated, and the pair of electrodes disposed such that the display layer and the photoconductor layer are interposed therebetween, with at least one of the electrodes comprising plural segmented electrodes juxtaposed along a predetermined direction, the voltage applying component being capable of applying a voltage simultaneously to a power receiving terminals of the segmented electrodes adjacent to each other, thereby apply a voltage to those adjacent two segmented electrodes;
a light irradiating component that irradiates, with writing light corresponding to image information, a region of the photoconductor layer corresponding to the segmented electrodes to which a voltage is being applied;
a relative moving component that moves the optically writable display medium and the light irradiating component relatively along the predetermined direction; and
a control component that controls the light irradiating component and the relative moving component such that, when the voltage is to be applied sequentially along the predetermined direction to the plural segmented electrodes by the voltage applying component to write an image on the optically writable display medium, while the voltage applying component is applying the voltage simultaneously to the power receiving terminals of adjacent two segmented electrodes, the region irradiated with the writing light by the light irradiating component shifts from a region corresponding to the segmented electrode of the two segmented electrodes that is upstream in the predetermined direction to a region corresponding to the segmented electrode that is downstream in the predetermined direction.

3. The optical writing device of claim 2, wherein
each of the plural segmented electrodes have a power receiving terminal from where the voltage applied with a contact by a contact electrode of the external power source, the each of the power receiving terminals disposed such that each of the power receiving terminals of each of the adjacent segmented electrodes are overlapped in the predetermined direction, but do not electrically contact each other,
the voltage applying component is a roll-like member capable of rotating in a state where it contacts the power receiving terminals, and
the relative moving component causes the optically writable display medium and the voltage applying component to relatively move along the predetermined direction such that a voltage is applied sequentially along the predetermined direction to the plural segmented electrodes.

4. An image display apparatus comprising:
an optically writable display medium; and
an optical writing device,
wherein
the optically writable display medium includes
a display layer that is capable of selectively reflecting incident light in response to an applied voltage and that has memory capability of its reflection state without the voltage,
a photoconductor layer whose electrical resistance changes in response to writing light with which the photoconductor layer is irradiated, and
a pair of electrodes disposed such that the display layer and the photoconductor layer are interposed therebetween, with at least one of the electrodes comprising plural segmented electrodes juxtaposed along a predetermined direction,
wherein each of the plural segmented electrodes have a power receiving terminal from where the voltage applied with a contact by a contact electrode of the external power source, the each of the power receiving terminals disposed such that each of the power receiving terminals of each of the adjacent segmented electrodes are overlapped in the predetermined direction, but do not electrically contact each other, and
the optical writing device includes
a voltage applying component that applies a voltage to the pair of electrodes of the optically writable display medium, the voltage applying component being capable of applying a voltage simultaneously to a power receiving terminals of the adjacent two segmented electrodes adjacent to each other, thereby apply a voltage to those adjacent two segmented electrodes,
a light irradiating component that irradiates, with writing light corresponding to image information, a region of the photoconductor layer corresponding to the segmented electrodes to which a voltage is being applied,
a relative moving component that moves the optically writable display medium and the light irradiating component relatively move along the predetermined direction, and
a control component that controls the light irradiating component and the relative moving component such that, when the voltage is to be applied sequentially along the predetermined direction to the plural segmented electrodes by the voltage applying component to write an image on the optically writable display medium, while the voltage applying component is applying the voltage simultaneously to the power receiving terminals of adjacent two segmented electrodes, the region irradiated with the writing light by the light irradiating component shifts from a region corresponding to the segmented electrode of the two segmented electrodes that is upstream in the predetermined direction to a region corresponding to the segmented electrode that is downstream in the predetermined direction.

5. The image display apparatus of claim 4,
each of the plural segmented electrodes have a power receiving terminal from where the voltage applied with a contact by a contact electrode of the external power source, the each of the power receiving terminals disposed such that each of the power receiving terminals of each of the adjacent segmented electrodes are overlapped in the predetermined direction, but do not electrically contact each other,
the voltage applying component is a roll-like member capable of rotating in a state where it contacts the power receiving terminals, and
the relative moving component causes the optically writable display medium and the voltage applying component to relatively move along the predetermined direction such that a voltage is applied sequentially along the predetermined direction to the plural segmented electrodes.
